(19) United States
(12) Patent Application Publication
(10) Pub. No.: US 2006/0116270 A1
(43) Pub. Date: Jun. 1, 2006

(54) Centrifuge system

(76) Inventors: Mehdi Hatamian, Coto De Caza, CA (US); Mehrtosh Ghalebi, Rancho Santa Margarita, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/184,544

(22) Filed: Jul. 18, 2005

Related U.S. Application Data
(60) Provisional application No. 60/588,720, filed on Jul. 16, 2004.

(30) Foreign Application Priority Data
Jul. 18, 2005 (WO) PCT/US05/25373

(51) Int. Cl. B04B 13/00; B01L 3/14; B04B 5/02

(52) U.S. Cl. 494/10; 422/102; 422/103; 422/915; 422/917; 422/918; 494/16; 251/65

(57) ABSTRACT

In some embodiments, a magnetically activated separation valve selectively permits fluid to flow before and during centrifugation, and obstructs fluid flow after centrifugation. The valve can be disposed in a sample container such as a test tube. In some embodiments, a centrifuge induces a magnetic field to open or close the valve. A portable embodiment of a centrifuge system allows samples to be processed more quickly outside of a traditional laboratory setting.

### RELATED APPLICATION

This application claims priority to pending U.S. Provisional Patent Application No. 60/588,720, filed Jul. 16, 2004, entitled CENTRIFUGE SYSTEM, the entirety of which is hereby incorporated by reference and made part of this specification.

### BACKGROUND OF THE INVENTIONS

1. Field of the Inventions

The inventions relate generally to centrifuge systems. In some embodiments, the inventions relate specifically to centrifuge systems for processing biological samples.

2. Description Of The Related Technology

In sample processing systems such as medical specimen testing systems, a sample frequently must be reduced to its component constituents with different specific gravities. Centrifuge systems are often used to separate such constituents of a sample. However, after the constituents of a sample have been separated, they can sometimes seep together and recombine. For this reason, physical barriers are sometimes provided to keep the separated constituents apart after centrifugation. In current devices, these physical barriers have many drawbacks that produce undesirable side effects.

In addition, existing centrifugation systems are generally large, bulky, and difficult to transport and use outside of the laboratory setting. This makes it very difficult to conduct centrifugation quickly on samples in urgent care situations.

### SUMMARY OF THE INVENTIONS

In some embodiments, a magnetically activated separation valve selectively permits fluid to flow before and during centrifugation, and obstructs fluid flow after centrifugation. The valve can be disposed in a sample container such as a test tube. In some embodiments, a centrifuge induces a magnetic field to open or close the valve. A portable embodiment of a centrifuge system allows samples to be processed more quickly outside of a traditional laboratory setting.

### BRIEF DESCRIPTION OF THE DRAWINGS

FIG. 1 is a plan view of one embodiment of a sample processing system.

FIG. 2 illustrates a side view of an embodiment of a centrifuge that can be used with the sample processing system of FIG. 1.

FIG. 3 illustrates a perspective view of the centrifuge of FIG. 2.

FIG. 4 illustrates a side view of a test tube with a magnetic valve that can be used in the centrifuge of FIG. 2.

FIG. 5 illustrates a cross-sectional side view of the test tube and magnetic valve of FIG. 4.

FIGS. 6A-6D schematically illustrate the fluid separation that can occur in a test tube with a magnetic valve when used with a centrifuge such as that of FIG. 2.

### DETAILED DESCRIPTION OF THE INVENTIONS

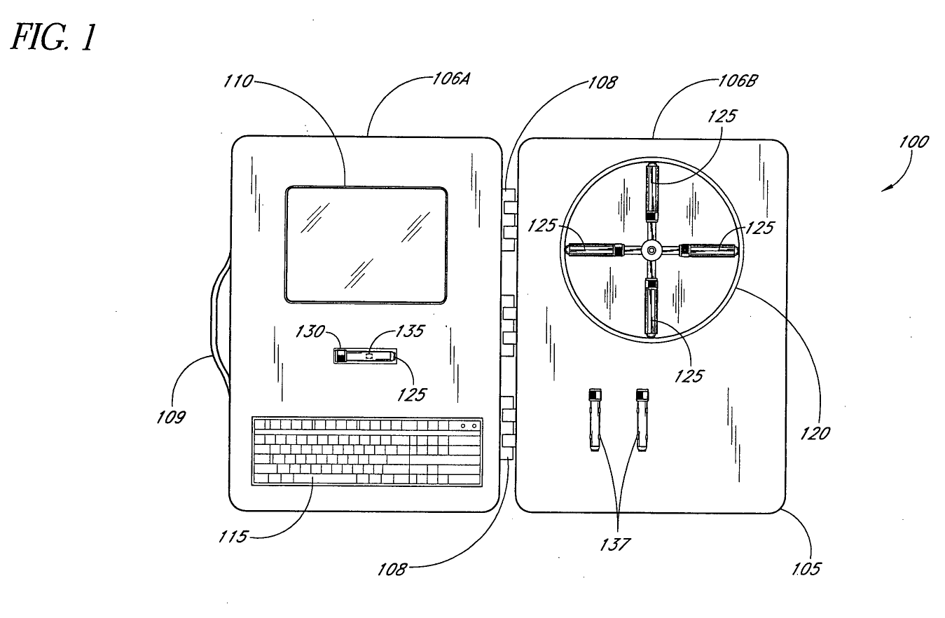

FIG. 1 illustrates one embodiment of a sample processing system, indicated generally by the reference numeral 100. The sample processing system 100, which can take many forms, as discussed more fully below, is useful in processing biological samples prior to testing by a medical professional. As is known, biological samples can rapidly decay after being removed from a patient. Accordingly, the processing provided by the sample processing system 100 places the sample in a more stable state so that it can be transported from the sample-taking location to another location and/or stored prior to further processing. In some applications, the sample processing system 100 is particularly useful for processing whole blood. One skilled in the art will recognize, however, that the sample processing system 100 can be used with a wide variety of samples, including biological and non-biological samples.

The sample processing system 100 is generally enclosed by a housing 105. In one embodiment, the housing 105 has a clamshell configuration. For example, the housing 105 can be formed with two opposing halves 106A, 106B that are joined by hinges 108 along corresponding edges of the two opposing halves 106A, 106B. In this configuration, the hinges 108 permit the opposing halves 106A, 106B and the housing 105 to move between a closed position and an open position. In the open position, the housing 105 exposes the contents of thereof for use. In the closed position, the housing 105 substantially encloses the contents thereof. Of course, other types of housings also can be used that provide access to at least some of the components of other embodiment of the sample processing system 100.

Preferably, the sample processing system 100, and the housing 105 that encloses the components thereof, is portable. The term “portable” is used in its ordinary sense and means, without limitation, that the system 100 can be easily transported by a user and used where convenient, e.g., generally where a patient is found. For example, the housing 105 is preferably provided with one or more handles 109. The system 100 also preferably is relatively small and light-weight. In one embodiment, the housing 105 is generally in the size and shape of a standard sized briefcase.

Preferably, the system 100 also includes a user interface 110 and a data entry device 115. In one embodiment, the user interface 110 comprises a visual display, an audible display, or a combination visual/audible display that displays sample information. The terms “sample information” and “processing information” are used in their ordinary sense and mean, without limitation, information related to a patient, a sample, a sample processing device or method, or any other information useful for processing a sample. A visual display could include an analog dial, a digital read-out, one or more light emitting diodes, a liquid crystal display, or any other suitable visual display. An audible display could include a speaker or any other suitable audible device. In the embodiment shown in FIG. 1, the user interface 110 comprises a visual monitor.

The data entry device 115 could include any mechanism for entering data for temporary or permanent storage. In the illustrated embodiment, the data entry device 115 comprises a keyboard. However, the data entry device 115 can be any suitable device that permits the user to enter and/or to edit processing information, e.g., a mouse, a microphone, etc. In another embodiment, the user interface 110 and the data entry device 115 are integrated, e.g., as a touch-screen display that is manipulated by a stylus or by a user's finger.

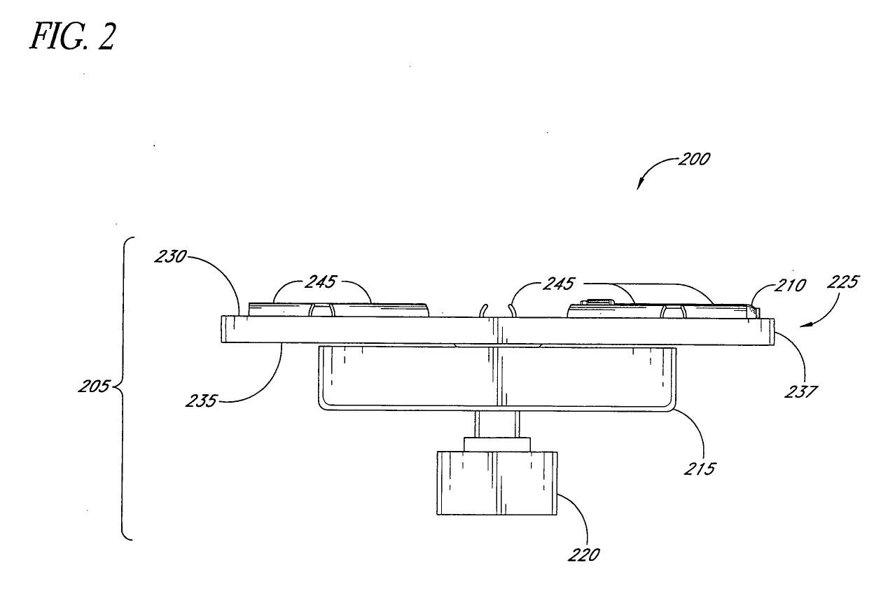

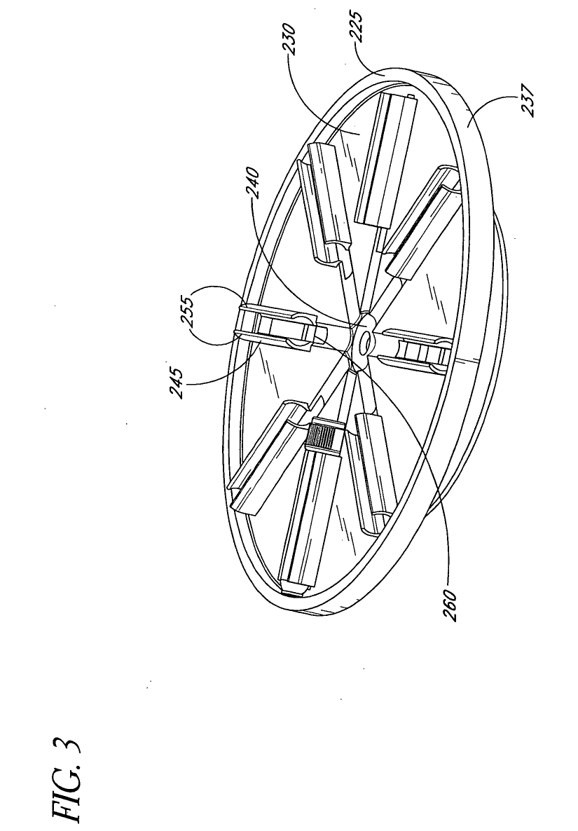

The sample processing system 100 also includes a centrifuge 120. The centrifuge 120 preferably is compact in construction. In one embodiment, the centrifuge 120 has a low profile, whereby the centrifuge 120 operates in a relatively small volume. In one embodiment, the centrifuge 120 is configured with a low profile by providing that all components thereof are maintain a fixed distance from an outer side of the opposing half 106B of the housing 105 throughout the operation of the centrifuge 120. For example, when the housing 105 is laid open on a horizontal surface, all the components of the centrifuge 120 remain in a same horizontal plane throughout the centrifuge process. Further details of one embodiment of the centrifuge 120 are set forth below in connection with FIGS. 2-3.

While the embodiment illustrated in FIG. 1 includes the centrifuge 120, other devices that process a sample could be incorporated into the sample processing system 100. Also, as discussed above, the system 100 can be used in connection with a variety of samples, including biological samples (e.g., whole blood) and non-biological samples.

The sample processing system 100 also includes a sample storage vessel 125 and a data transfer device 130. In one embodiment, the sample storage vessel 125 includes a data storage element 135. As used herein, the term “sample storage vessel” is used in its ordinary senses and means, without limitation, any container for holding a sample, e.g., a test tube, a flask, or any other suitable sample holding container that can contain a sample for a relatively long period. However, a test tube is one sample storage vessel that is particularly well suited for a centrifuging process. Preferably, the data transfer device 130 can be coupled with the data storage element of the sample storage vessel 125, whereby the processing information can be stored and kept with the sample storage vessel 125.

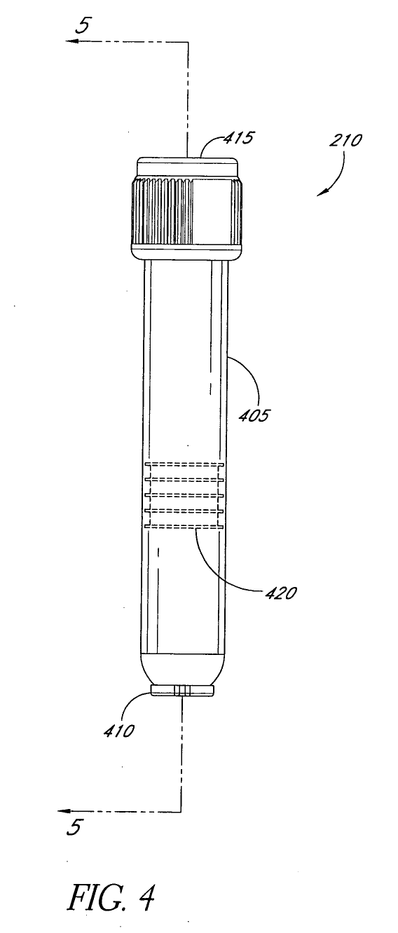

The data storage element 135 can be any device that can receive data and store data permanently. The term “permanent” and its variants is used herein in its ordinary sense and means, without limitation, that data is retained for an extended time, e.g., at least for the useful life of a sample storage vessel 125, as described herein. Preferably, the data storage element 135 is an electronic element, i.e., an element to which data is written electrically or magnetically. Further details of the sample storage vessel 125 are set forth below in connection with FIGS. 4-6.

In one embodiment, the data transfer device 130 comprises a slot into which the sample vessel 125 is inserted. However, the data transfer device 130 could be configured to transmit data to the data storage element 135 while the associated sample storage vessel 125 is coupled to the centrifuge 120. For example, in one embodiment, data is transferred to the data storage element 135 after the centrifuge 120 completes operation. In another embodiment, data is transferred to the data storage element 135 before the centrifuge 120 completes operation. In another embodiment, data is transferred to the data storage element 135 while the centrifuge 120 is operating.

The housing 105 is configured to enclose, at least partially, each of the foregoing components of the sample processing system 100. The housing 105 can also be provided with locations to store one or more sample storage vessels 125 either before or after the sample storage vessel 125 has been filled with a sample. For example, one ore more storage clamps 137 can be provided to hold sample storage vessels 125. Other components can also be included in the sample processing system 100, such as syringes and catheters for accessing and transferring whole blood from a patient to the sample storage vessel 125.

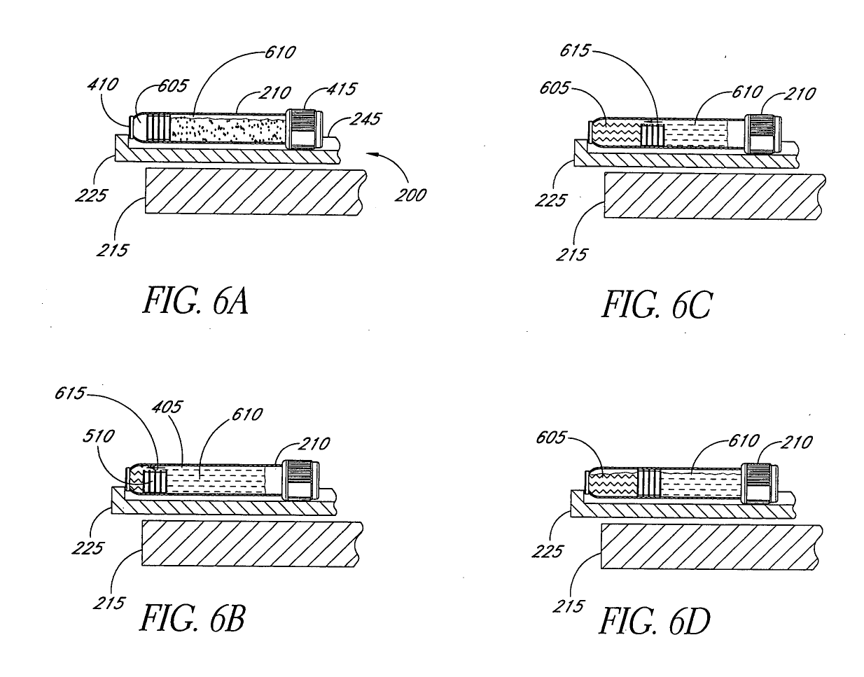

FIG. 2 shows one embodiment of a centrifuge system 200. The centrifuge system 200 includes a centrifuge 205, a sample vessel 210, and a sample vessel valve actuator 215. The centrifuge 205 is configured to receive the sample vessel 210 containing a sample and to process the sample. As discussed in more detail below in connection with FIGS. 6(a)-6(d), the sample vessel valve actuator 215 manipulates a valve located in the sample vessel 210 to facilitate and to maintain separation of components of the sample (e.g., whole blood) in the centrifuge 205.

The centrifuge 205 includes a motor 220 and a wheel 225 coupled to the motor 220. The wheel 225 includes a first surface 230, a second surface 235, an outer periphery 237, and a hub 240. The hub 240 includes the inner-most portion of the wheel 225, extends from the second surface 235 of the wheel 225, and is coupled with the motor 220. A plurality of sample vessel clamps 245 are located on the first surface 230 of the wheel 225. The hub 240 is coupled with a shaft of the motor 220 and rotation of the shaft is transferred to the wheel 225 through the hub 240. Thus, the motor 220 can cause the wheel 225 and the sample vessel clamps 245 located thereon to rotate.

In the illustrated embodiment, each of the sample vessel clamps 245 includes a pair of jaws 255 and an elongate recess 260 formed on the first surface 230 of the wheel 225. The elongate recess 260 preferably extends parallel to a radius of the wheel 225 and has an arcuate transverse cross-section. In one embodiment, the jaws 255 are formed as a pair of members that extend generally upwardly from the first surface 230 of the wheel 225. The elongate members extend along the elongate recess 260 and have an arcuate transverse cross-section. Thus, in one embodiment, the jaws 255 and the recess 260 at least partially define a cylindrical volume that extends from the outer periphery 237 to a location between the outer periphery 237 and the hub 240.

The upper-most portion of the jaws 255 are spaced apart by a distance that is less than the transverse dimension of the sample vessel 210. Thus, to insert the sample vessel 210 into the sample vessel clamp 245, the sample vessel 210 must be urged against the upper-most portion of the jaws 255 to spread the jaws 255. Once the jaws 255 are spread, the sample vessel 210 can be advanced into the cylindrical volume defined by the jaws 255 and the recess 260. Once in the cylindrical volume, the sample vessel clamp 245 applies pressure to the sample vessel 210, which prevents the sample vessel 210 from moving. In one embodiment, one end of the jaws 255 located is adjacent the outer periphery 237 so that when a sample vessel 210 is positioned in the jaws 255, a portion of the sample vessel 210 abuts against the outer periphery 237 to prevent the sample vessel 210 from moving radially outwardly when the wheel 225 is rotated.

While any suitable clamp that secures the sample vessel 210 in position on the centrifuge 205 can be used, the sample vessel clamp 245 is particularly advantageous. For example, the sample vessel clamp 245 has no moving parts that alter the orientation of the sample vessel 210 during operation of the centrifuge system 200. Thus, the sample vessel clamp 245 can be easily manufactured. In addition, having no moving parts, the longitudinal axis of the cylindrical volume defined by the sample vessel clamp 245, and the longitudinal axis of the sample vessel 210 held thereby can be maintained in a single plane throughout the operation of the centrifuge 220. For this and other reasons discussed above, the centrifuge 220 can be made with a very low profile.

In the illustrated embodiment, the centrifuge 205 comprises eight sample vessel clamps 245 that are located on the first surface 230 of the wheel 225. Other numbers of sample vessel clamps 245 can be provided. For example, the centrifuge 120 of FIG. 1 comprises four sample vessel clamps.

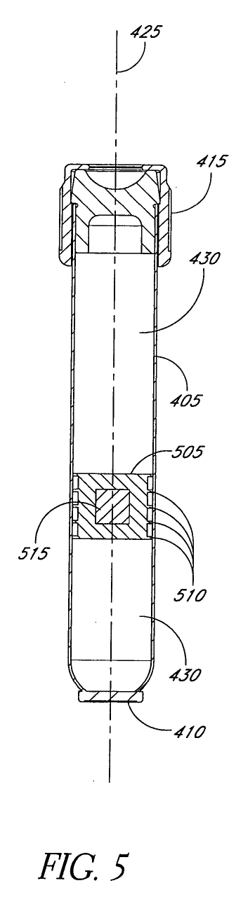

FIGS. 4 and 5 illustrate one embodiment of a sample vessel 210. The sample vessel 210 includes a cylindrical container 405, a data storage element 410, a closure member 415, and a valve 420. The cylindrical container 405 extends along a sample vessel longitudinal axis 425 (See FIG. 5) and has an inner perimeter of a selected size. The cylindrical container 405 defines a sample volume 430. The cylindrical container 405 preferably is made of a material that has sufficient durability to be processed in the centrifuge 205 (e.g., to be inserted into the sample vessel clamp 245 and rotated by the centrifuge 205), and in a variety of other sample processing devices. The cylindrical container 405 preferably is made of a material that has sufficient durability to be transported between a plurality of testing stations within a laboratory or to be transported between laboratories.

The data storage element 410 is a device that stores processing information related the sample contained in the sample vessel 210. In one embodiment, the data storage element 410 comprises a permanent memory device. As discussed above in connection with FIG. 1, the data storage device 410 is configured to couple with a data transfer device that imparts relevant processing information to the data storage device 410. The memory provided by the data storage device 410 is a persistent memory, wherein the information stored therein remains with the sample vessel 210 throughout the useful life of the sample vessel 210.

The persistent memory of the data storage device 410 provides many advantages. For example, a great deal of processing information is generated in connection with typical biological samples. For example, the sample is taken from a particular patient under specific circumstances that may be relevant to further analysis. Some samples may require processing within a specified time from the taking of the sample. Thus, the time at which the sample was taken is relevant processing information to be saved and kept with the sample. Also, most samples are taken to perform one or more tests specified by a medical professional. It is important that the sample be directed to the correct test because the sample usually will be destroyed during the test. If the wrong test is performed, the patient will be required to return to provide an additional sample. Worse yet, a delay will result, which could be prevent timely diagnosis and delay treatments for which time is of the essence. Thus, the prescribed test is relevant processing information to be kept with the sample. Also, most tests generate a test result that is used to analyze the health of the patient and/or to inform a medical professional as to the treatment required. The result must be matched with the sample, or at the least matched with the patient from whom the sample was taken, or else the correct treatment indicated by the test will be given to the wrong patient.

Without the data storage element 410, the relevant processing information normally would be hand-written on a label, which could be lost, be rendered unreadable, or otherwise become inoperative. Moreover, as discussed in more detail below, existing test tubes used to store biological samples seldom remain with the sample for very long. Rather the sample is very quickly transferred to another container. Accordingly, the processing information discussed above must be transferred from one label to another label each time a sample is transferred from one test tube to another test tube. One can appreciate that the transfer of the sample and the transcription of the processing information provides many opportunities for the sample and the processing information to become corrupted. In contrast, the data storage element 410 remains at all times with the sample vessel 210 and does not required any data transcription. Rather, the data storage element 410 can interact with sample processing equipment to update data stored therein. This enables the processing information to be accessible and retrievable for further reference and use. Further features of the sample vessel 210 discussed below prolong its life during handling and storage of a single sample.

In one embodiment, the closure member 415 is a standard stopper for a test tube. The closure member 415 is made of a biocompatible material so that the sample contained in the sample volume will not be corrupted by interaction with the closure member 415. In one embodiment, the closure member 415 is knurled around an upper side edge, e.g., having ridges to facilitate gripping by a user. Also, the closure member 415 preferably is color coded, whereby the color of the closure member 415 indicates, at least in part, how the sample vessel 210 is to be handled or processed.

FIG. 5 shows the structure of one embodiment of the valve 420 in greater detail. The valve 420 includes a plug member 505 that has an outer perimeter of a selected size. In one embodiment, the plug member 505 is a cylindrical member that has a diameter that is less than the inner perimeter of the cylindrical container 405. The valve 420 also includes five flexible rings 510 that extend around the outer perimeter of the cylindrical plug member 505. The rings 510 are configured to form a seal with the inner wall of the cylindrical container 405. For example, in one embodiment, the rings 510 are flexible members that have an outer perimeter that is less than the perimeter of the inner wall of the cylindrical container 405. The seal formed between the rings 510 and the cylindrical container 405 is discussed in greater detail below.

While five flexible rings 510 are shown, a lesser number could also be employed. For example, one or more flexible rings 510 could be provided around the outer perimeter of the cylindrical plug member 505. Also, the rings 510 could be eliminated entirely if the plug member 505 is configured to form a seal with the inner wall of the cylindrical container 405. While fewer than five flexible rings 510 could be provided, the illustrated embodiment is particularly useful for isolating components of a sample in the sample volume 430 in that together the rings 510 provide a series of barriers, which in turn provides greater isolation.

The valve 420 also includes a ferrous material 515 is a monolithic member that is embedded within the plug 505. In one embodiment, the ferrous material 515 is embedded in the plug 505. In the illustrated embodiment, the ferrous material 515 comprises a cylindrical member that is centered on the sample vessel longitudinal axis 425 when the valve 420 is closed, as discussed below. The ferrous material 515 can take other shapes as well. For example, several smaller, distinct ferrous portions could be provided within the plug 505. In one embodiment, an array of ferrous portions is provided within the plug 505. In some embodiments, the ferrous portions are uniformly distributed within the plug 505. In other embodiments, the ferrous portions are unevenly distributed. The position of the ferrous material 515 and its distribution may provide advantages in connection with the valve actuator 215, discussed in more detail below.

The valve 420 in the sample vessel 210 is actuated by the valve actuator 215 during centrifugation to facilitate isolation of the various components of the sample. As discussed above, in one embodiment, the valve 420 comprises a ferrous material, or a ferrous portion, embedded within the plug member 505 and the valve actuator 215 comprises an electromagnet. As described in more detail below in connection with FIGS. 6(a)-6(e), the plug member 505 interacts with the electromagnet of the valve actuator 215. This interaction causes the valve 420 selectively to be opened and closed. When open, the valve 420 allows the flow of the sample around the valve 420. When closed, the valve 420 blocks the flow of sample around the valve 420. Also, as discussed below, the interaction between the electromagnet of the valve actuator 215 and the ferrous material within the valve 420 causes the valve 420 to be moved, if desired, from a first position in the sample volume 430 to a second position in the sample volume 430. In some applications, the second position is determined based on properties of the sample. For example, in some centrifugation processes a predictable percentage of whole blood is red blood cells. Thus, the valve 420 can be moved during centrifugation to a position that corresponds to the percentage of red blood cells in the whole blood.

FIGS. 6(a)-6(d) further illustrate the operation of one embodiment of the centrifuge system 200. FIG. 6(a) shows a portion of a partial cross-section of the centrifuge system 200 through one of the sample vessel clamps 245. In this figure, the wheel 225 of the centrifuge 205 has not yet begun to rotate. As can be seen, a sample vessel 210 having a sample of whole blood is positioned in a sample vessel clamp 245. Also, the electromagnet of the valve actuator 215 has not been energized, so the valve 420 is closed. The valve 420 is located in a first position in the sample vessel 210. The first position is adjacent the bottom of the sample vessel 210. When closed, the plug member 505 of the valve 420 is centered on the sample vessel longitudinal axis 425 and the rings 510 extend outwardly form the plug member 505 to engage the inner wall of the cylindrical container 405. Thus, each of the rings 510 forms a seal with the inner wall of the cylindrical container 405. Each of the rings 510 also form a portion of a seal the between a first chamber 605, defined between the valve 420 and the data storage element 410, and a second chamber 610, defined between the valve 420 and the closure member 415. As discussed in more detail below, the relative size of the first chamber 605 and the second chamber 610 can change during use of the centrifuge system 200. The multiple rings 510 of the valve 420 provide some redundancy and improve the isolation of the first chamber portion 605 and the second chamber portion 610. In FIG. 6(a), a sample of whole blood is located in the second chamber portion 610.

FIG. 6(b) is similar to FIG. 6(a), but shows the valve 420 opened and the wheel 225 of the centrifuge 205 being rotated. To open the valve 420, the electromagnet of the valve actuator 215 is energized. This causes the ferrous material 515 embedded in the plug member 505 to be displaced in a direction that is generally transverse to the longitudinal axis of the sample vessel longitudinal axis. For example, as shown in FIG. 6(b), the plug member 505 can be urged transversely toward the valve actuator 215 by the interaction of the magnetic field and the ferrous material 515 embedded in the plug member 505. This movement causes a space to be created between the rings 510 and the inner surface of the cylindrical container 405, which space provides fluid communication between the first chamber portion 605 and the second chamber portion 610. When the valve 420 is opened, the sample (e.g., the whole blood) in the sample vessel 210 can move between the valve 420 and the inner surface of the cylindrical container 405, as indicated by the arrow 615. When the valve 420 is open, the whole blood, or at least a higher density component thereof, flows from the second chamber 610 to the first chamber 605. Thus, the components of the whole blood having higher density are separated from the components of the whole blood having a lower density.

FIG. 6(c) illustrates that the valve 420, in some embodiments, is also movable within the sample volume 430 of the sample vessel 210. In one embodiment, the strength and orientation of the magnetic field generated by the electromagnet of the valve actuator 215 and the size and shape of the ferrous material 515 are selected to cause the valve 420 to move within the sample volume 430. As can be seen in FIG. 6(c), the valve 420 has moved from the first position adjacent the bottom of the sample vessel 210 to the second, which is a position closer to the closure member 415 than is the first position of the valve 420. As discussed above, this position can be selected based on the expected amount of higher density material to be separated from lower density material. For example, in one embodiment, the second position is selected to provide a volume between the valve 420 and the bottom of the sample vessel 210 that corresponds to the expected volume of red blood cells in a typical sample of whole blood.

FIG. 6(d) illustrates the end of the centrifugation process carried out in the centrifuge system 200. At this stage, the electromagnet of the valve actuator has been de-energized, which has caused the valve 420 to close. As described above, when the valve is closed, the rings 510 engage the inner surface of the cylindrical container 405. A seal is thereby created between the first chamber 605 and the second chamber 610. This seal effectively isolates the first and second chambers 605, 610. Thus, in the case of whole blood that has been centrifuged, the red blood cells can be isolated in the first chamber 605 from the rest of the blood, which is in the second chamber 610.

Although the centrifuge system 200 includes a valve actuator that has an electromagnet, other magnetic arrangements could be provided to actuate the valve 420. In other embodiments, the valve 420 could be a mechanical valve rather than a magnetic valve. If a mechanical valve is used, the valve actuator 215 may not be needed. For example, a mechanical valve could be actuated by the forces generated by the rotation of the sample vessel 210 (e.g., centrifugal forces). Such a mechanical valve could employ a spring, such as a leaf spring, that is configured to be actuated by such forces.

Although the present invention has been described in terms of certain preferred embodiments, other embodiments apparent to those of ordinary skill in the art also are within the scope of this invention. Thus, various changes and modifications may be made without departing from the spirit and scope of the invention. Moreover, not all of the features, aspects and advantages are necessarily required to practice the present invention. Accordingly, the scope of the present invention is intended to be defined only by the claims that follow.

What is claimed is:

1. A system for maintaining fluid separation comprising:
a fluid container;
a magnetically actuated valve within the fluid container; and
a centrifuge that positions the valve to allow fluid to flow past the valve while the centrifuge is spinning.

2. The system of claim 1, wherein the fluid container is a test tube.

3. The system of claim 1, wherein the fluid container comprises a data storage element.

4. The system of claim 3, wherein the data storage element comprises an electronic element.

5. The system of claim 1, wherein the centrifuge positions the valve by creating forces in a radial direction that displace a resilient member.

6. The system of claim 5, wherein the resilient member is a leaf spring.

7. A valve for maintaining fluid separation in a generally cylindrical vessel comprising:
a plug member having a first diameter less than a diameter of the cylindrical vessel;
at least one flexible ring extending to a second diameter greater than the first diameter; and
a ferrous portion embedded within the plug member.

8. A centrifuge for actuating the valve of claim 7 comprising a magnet.

9. The centrifuge of claim 8 wherein the magnet is an electromagnet.

10. A centrifuge system for separating at least two components of a sample comprising:
a sample vessel having a sample vessel longitudinal axis, a first chamber, a second chamber, and a magnetic valve positioned between the first chamber and the second chamber;
a motor having an axis of rotation; and
a sample vessel holder coupled for rotation with the motor, the sample vessel holder configured to receive the sample vessel and to maintain the sample vessel longitudinal axis in a plane that is perpendicular to the axis of rotation of the motor.

11. The centrifuge system of claim 10, wherein the valve is configured to be actuated between an open position allowing fluid communication between the first chamber and the second chamber and a closed position blocking fluid communication between the first chamber and the second chamber.

12. The centrifuge system of claim 10, further comprising a sample vessel valve actuator that can be selectively coupled with the valve to actuate the valve.

13. The centrifuge system of claim 12, wherein the sample vessel valve actuator further comprises an electromagnet and the sample vessel valve further comprises a ferrous material that responds to a magnetic field generated by the sample vessel valve actuator.

14. The centrifuge system of claim 12, wherein the valve comprises a spring responsive to forces generated by the rotation of the sample vessel such that above a selected rotational speed, the spring is overcome and the valve provides fluid communication between the first chamber and the second chamber.

15. The centrifuge system of claim 10, wherein the sample vessel comprises a test tube.

16. A durable sample vessel, comprising:
a test tube defining a sample holding volume and an open end to receive a sample;
a valve disposed in the sample volume, the valve separating the sample volume into a first chamber and a second chamber, the valve configured to be actuated between an open position allowing fluid communication between the first chamber and the second chamber and a closed position blocking fluid communication between the first chamber and the second chamber; and
a data storage element coupled with the test tube, the data storage element configured to receive and store data corresponding to the contents of the sample vessel.

17. The durable sample vessel of claim 16, wherein the data storage element is embedded in a wall of the test tube.

18. The durable sample vessel of claim 16, wherein the valve further comprises a ferrous material.

19. The durable sample vessel of claim 16, wherein the valve further comprises a flexible member, an extending portion, and a ferrous material, the flexible member having an outer perimeter that is less than the inner perimeter of the test tube, the extending portion extending outwardly from the flexible member such that the outer perimeter of the extending portion is greater than the inner perimeter of the test tube.

20. The durable sample vessel of claim 19, wherein the extending portion further comprises a plurality of ridges extending outwardly from the flexible member, the ridges spaced along the length of the flexible member.

21. The durable sample vessel of claim 20, wherein the flexible member is cylindrical in shape and wherein the extending portion further comprises five rings

22. The durable sample element of claim 16, wherein the valve is mechanically actuated.

23. The durable sample element of claim 22, further comprising a leaf spring having a stiffness corresponding to a centrifugal force generated by rotation of the sample element at a specified rotational speed.

24. The durable sample element of claim 16, wherein the valve is magnetically actuated.

25. The durable sample element of claim 24, wherein the valve further comprises a sealing portion and a ferrous portion, the ferrous portion embedded in the sealing portion, the ferrous portion responsive to a selected magnetic field to alter the shape of the sealing portion to permit leakage between the sealing portion and the wall of the test tube.

26. The durable sample element of claim 25, wherein the ferrous portion is responsive to the selected magnetic field to be displaced within the sample holding volume to a selected position.

27. The durable sample element of claim 16, wherein the data storage element comprises a data security module that prevents unauthorized personnel from retrieving data stored therein.

28. A valve for maintaining fluid separation in a generally cylindrical vessel comprising:
a plug member having a first diameter less than a diameter of the cylindrical vessel;
at least one flexible ring extending to a second diameter greater than the first diameter; and
a ferrous portion embedded within the plug member.

29. A centrifuge for actuating the valve of claim 28 comprising a magnet.

30. The centrifuge of claim 29 wherein the magnet is an electromagnet.

31. A method of separating fluid comprising:
inserting fluid into a sample vessel having a first chamber, a second chamber, and a magnetic valve positioned between the first chamber and the second chamber;
spinning the sample vessel in a centrifuge;
actuating the magnetic valve with a magnet.
